(19) United States
(12) Patent Application Publication
(10) Pub. No.: US 2013/0107134 A1
(43) Pub. Date: May 2, 2013

(54) LIGHTING DEVICE, DISPLAY DEVICE AND TELEVISION RECEIVER

(71) Applicant: Tatsuro Kuroda, Osaka-shi (JP)

(72) Inventor: Tatsuro Kuroda, Osaka-shi (JP)

(73) Assignee: SHARP KABUSHIKI KAISHA, Osaka-shi, Osaka (JP)

(21) Appl. No.: 13/805,018

(22) PCT Filed: May 24, 2011
(86) PCT No.: PCT/JP2011/061860

§ 371 Date: Dec. 18, 2012

(30) Foreign Application Priority Data
Jun. 24, 2010 (JP) 2010-143906

(51) Int. Cl. G09F 13/04; G02F 1/1335; H04N 5/66

(52) U.S. Cl. CPC G09F 13/04; H04N 5/66; G02F 1/1336
USPC 348/790; 362/97.1; 349/61

(57) ABSTRACT

In order to provide a lighting device such that a light source and a connector can be connected with increased reliability in a simple configuration, a lighting device according to the present invention is provided with: a light source including a light emitting portion and a conductive portion extending from an end portion of the light emitting portion; a power source supplying drive power to the light source; and connectors including a connecting terminal configured to connect the light source and the power source by sandwiching the conductive portion. The conductive portion includes a retaining section with a width greater than a width of an adjoining portion that prevents the conductive portion from coming off the connecting terminal by interfering with the connecting terminal.

### TECHNICAL FIELD

The present invention relates to a lighting device, a display device, and a television receiver.

### BACKGROUND ART

A liquid crystal panel used in a liquid crystal display device, such as a liquid crystal television set, does not emit light by itself. Thus, the liquid crystal panel uses a backlight unit as a separate lighting device. The backlight unit is installed on the rear side (opposite to the display surface) of the liquid crystal panel, and provided with a number of light sources (such as cold cathode tubes); a power supply board configured to supply power to the light sources; and a connector electrically connecting the light sources and the power supply board.

A specific example of the structure of the connector as a constituent component of the backlight unit is described in Patent Document 1 indicated below. In this example, the connector includes a connecting terminal sandwiching an outer lead provided at the end portion of a cold cathode tube, and an operating member with a pressing portion pressing the connecting terminal, such that the outer lead can be sandwiched by the connecting terminal with increased sandwiching force.
Patent Document 1: Japanese Unexamined Patent Publication No. 2007-48716

### PROBLEM TO BE SOLVED BY THE INVENTION

If the liquid crystal display device is subjected to strong vibrations or shock during assembly or transport, the outer lead sandwiched by the connecting terminal may come off and become disconnected. While the connector according to Patent Document 1 is configured such that the sandwiching force of the connecting terminal against the outer lead can be increased by pressing the connecting terminal with the pressing portion, this may not ensure vibration resisting performance or shock resisting performance against strong vibrations or shock during assembly or transport. Thus, the configuration of Patent Document 1 is insufficient in preventing coming-off of the outer lead, and there is still room for improvement. Further, the structure of the connector is complex such that the outer lead cannot be connected to the connector simply and easily, resulting in an increase in cost.

### DISCLOSURE OF THE PRESENT INVENTION

The present invention was made in view of the above circumstances, and an object of the present invention to provide a lighting device such that the connection reliability between the light source and the connector can be increased in a simple configuration. Another object of the present invention is to provide a display device with such a lighting device and a television receiver with such a display device.

### MEANS FOR SOLVING THE PROBLEM

In order to solve the problem, a lighting device according to the present invention includes a light source including a light emitting portion and a conductive portion extending from an end portion of the light emitting portion; a power source configured to supply drive power to the light source; and a connector including connecting terminals holding the conductive portion therebetween to connect the light source to the power source. The conductive portion includes a retaining section larger in width than another section of the conductive portion such that the retaining section is caught by the connecting terminals and remains held by the connecting terminals.

In this configuration, even when the lighting device is subjected to strong vibrations or shock during assembly or transport, the light source and the connecting terminals can be prevented from being inadvertently disconnected by the retaining section of the light source interfering with the connecting terminals of the connector. Thus, vibration resisting performance and shock resisting performance can be ensured, and thereby the connection reliability between the light source and the connector can be increased. Further, according to the present configuration, the connection reliability is increased by varying the width of the conductive portion of the light source, and thereby cost reduction can be achieved without a complicated structure of the connector to which the light source is connected.

The width of the retaining section may be larger than a distance between the connecting terminals with which the conductive portion is held.

In this configuration, when force is applied to pull the conductive portion off the connecting terminal, the retaining section is abutted on the connecting terminal, or strong friction is caused between the retaining section and the connecting terminals, because the retaining section is larger in width than the distance between the connecting terminals. Due to such operation of the retaining section, the conductive portion can be prevented from coming off the connecting terminals, and thereby the connection reliability between the conductive portion and the connecting terminals can be increased.

The retaining section may be located closer to a distal end of the conductive portion than a section of the conductive portion held by the connecting terminals.

In this configuration, when force is applied to pull the conductive portion off the connecting terminal, the retaining section at the distal end of the conductive portion is abutted on surfaces of the connecting terminals toward which the retaining section is faced such that the movement of the conductive portion is limited. Thus, the conductive portion is prevented from coming off.

The width of the retaining section may be larger in width on a distal side than on a side closer to the light emitting portion, and the retaining section may include a side surface faced toward the connecting terminal and angled to a surface of the connecting terminal.

In this configuration, when the conductive portion is moved in the pulling-off direction, the retaining section and the connecting terminal are abutted on each other while conforming to a side surface of the retaining section such that the shock upon abutting can be decreased. Thus, damage to the conductive portion can be avoided.

The retaining section may be provided in a section of the conductive portion held by the connecting terminals.

In this configuration, when force is applied to pull the conductive portion off the connecting terminal, strong friction is caused between the retaining section and the connecting terminal such that the conductive portion can be prevented from coming off.

The retaining section may include an arc-like shaped surface facing the connecting terminal.

In this configuration, because the retaining section and the connecting terminals come into contact with each other while conforming to the arc-like shaped surface, the conductive portion can be prevented from being subjected to localized shock when the conductive portion is moved. Thus, damage to the conductive portion can be avoided.

The conductive portion may include a convex portion and a concave portion adjacent to each other, and the convex portion may be the retaining section.

In this configuration, when force is applied to pull the conductive portion off the connecting terminal, the retaining section is deformed toward the concave portion such that the contact resistance between the retaining section and the connecting terminal is increased. As a result, the friction between the conductive portion (retaining section) and the connecting terminal is increased, and thereby the conductive portion can be prevented from coming off.

The retaining section may form a ridge extending in a direction intersecting an extending direction of the conductive portion.

In this configuration, when force is applied to the conductive portion in the extending direction, greater friction can be caused between the conductive portion (retaining section) and the connecting terminal than a dot-like retaining section, for example. Thus, retaining effect of the conductive portion can be increased.

The width of the conductive portion may be gradually increased from a side closer to the light emitting portion toward a distal side, and the retaining section may be a distal side portion of the conductive portion.

In this configuration, the retaining section can be formed by simply varying the width of the conductive portion continuously, and thereby retaining effect of the conductive portion can be obtained in a simple configuration, leading to cost reduction. Because the width of the conductive portion is continuously varied, the connecting terminal can readily conform to the outer surface of the conductive portion. Thus good connection between the conductive portion and the connecting terminal can be obtained.

The retaining section may be integrally formed with the conductive portion.

In this case, the number of components can be decreased and cost reduction can be achieved.

The connecting terminal may include a pair of elastic contact parts elastically in contact with the conductive portion.

In this way, when the conductive portion is sandwiched by the pair of elastic contact parts of the connecting terminal, the pair of elastic contact parts elastically contacts the conductive portion. Thus, good connection between the conductive portion and the connecting terminal can be maintained and better connection reliability can be achieved.

In order to solve the problem, a display device according to the present invention includes the lighting device; and a display panel configured to provide a display by utilizing light from the lighting device.

In this display device, the lighting device that supplies light to the display panel has excellent connection reliability between the light source and the connector. Therefore, stable display can be provided.

The display panel may be a liquid crystal panel. The display device as a liquid crystal display device may be applied to various purposes, including displays for televisions and personal computers, and is particularly suitable for large screens.

A television receiver according to the present invention includes the display device.

According to this television receiver, an apparatus with excellent display reliability can be provided.

### ADVANTAGEOUS EFFECT OF THE INVENTION

According to the lighting device of the present invention, the connection reliability between the light source and the connector can be increased by a simple configuration. The display device according to the present invention can provide stable display because the display device is provided with the lighting device. Further, the television receiver according to the present invention can provide an apparatus with excellent display reliability because the television receiver is provided with the display device.

### BRIEF DESCRIPTION OF THE DRAWINGS

FIG. 1 is an exploded perspective view illustrating a schematic configuration of a television receiver according to the first embodiment of the present invention;

FIG. 2 is an exploded perspective view illustrating a schematic configuration of a liquid crystal display device included in the television receiver;

FIG. 3 is a cross sectional view illustrating a cross sectional configuration of the liquid crystal display device along a long side direction;

FIG. 4 is a plan view illustrating an arrangement of cold cathode tubes, connectors, and a chassis of the liquid crystal display device;

FIG. 5 is an enlarged cross-sectional view of main parts of the liquid crystal display device along a long side direction thereof, illustrating the connection of the cold cathode tubes and the connectors;

FIG. 6 is a perspective view illustrating a configuration of an end portion of the cold cathode tubes;

FIG. 7 is a plan view illustrating a configuration for connecting the cold cathode tubes and the connectors;

FIG. 8 is a partially cutaway schematic cross sectional view taken along line A-A of FIG. 7;

FIG. 9 is a partially cutaway schematic cross sectional view taken along line B-B of FIG. 7;

FIG. 10 is a perspective view illustrating a configuration of an end portion of a cold cathode tubes according to the second embodiment of the present invention;

FIG. 11 is a plan view illustrating a configuration for connecting the cold cathode tubes and the connectors;

FIG. 12 is a perspective view illustrating a configuration of an end portion of a cold cathode tubes according to the third embodiment of the present invention;

FIG. 13 is a plan view illustrating a configuration for connecting the cold cathode tubes and the connectors;

FIG. 14 is a perspective view illustrating a configuration of an end portion of a cold cathode tubes according to the fourth embodiment of the present invention;

FIG. 15 is a plan view illustrating a configuration for connecting the cold cathode tubes and the connectors;

FIG. 16 is a perspective view illustrating a configuration of an end portion of a cold cathode tubes according to a modification;

FIG. 17 is a perspective view illustrating a configuration of an end portion of a cold cathode tubes according to a modification;

FIG. 18 is a perspective view illustrating a configuration of an end portion of a cold cathode tubes according to a modification; and

FIG. 19 is a perspective view illustrating a configuration of an end portion of a cold cathode tubes according to a modification.

### BEST MODE FOR CARRYING OUT THE INVENTION

### First Embodiment

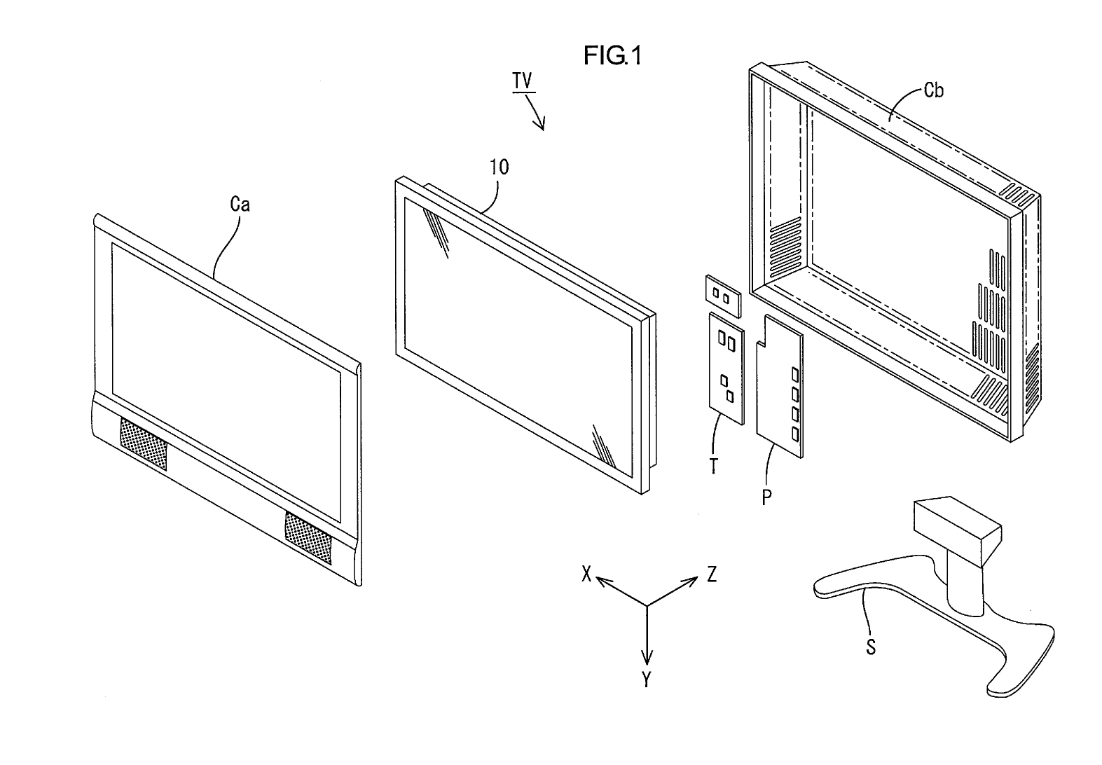

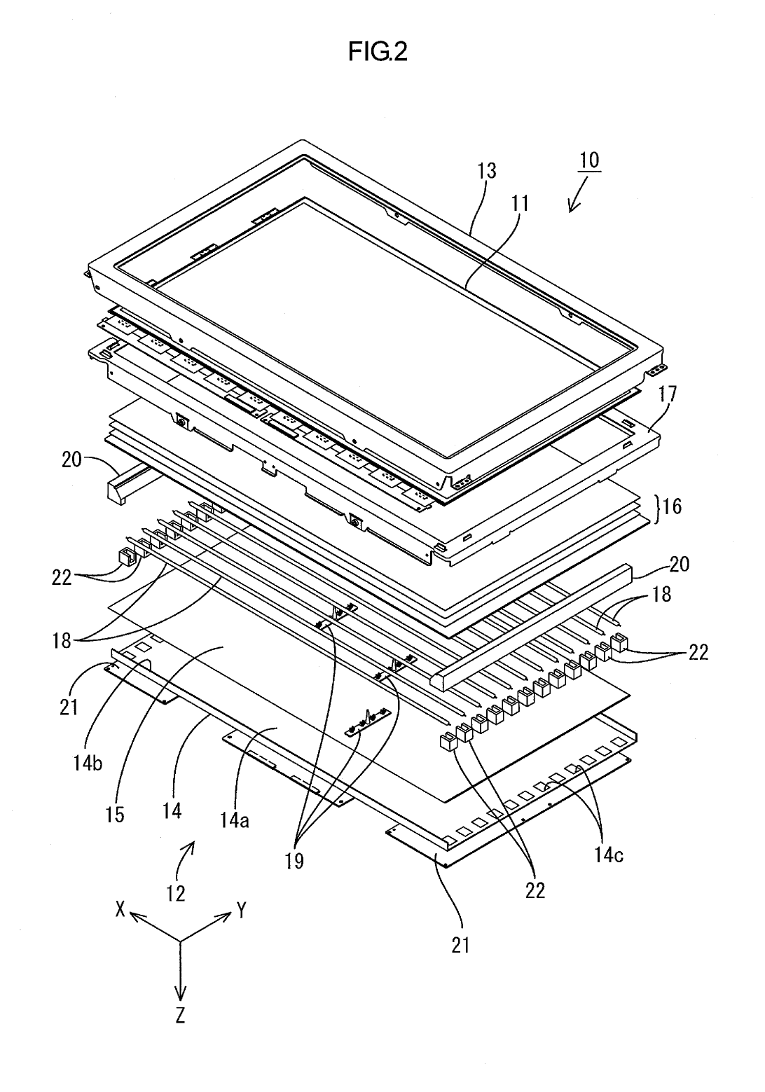

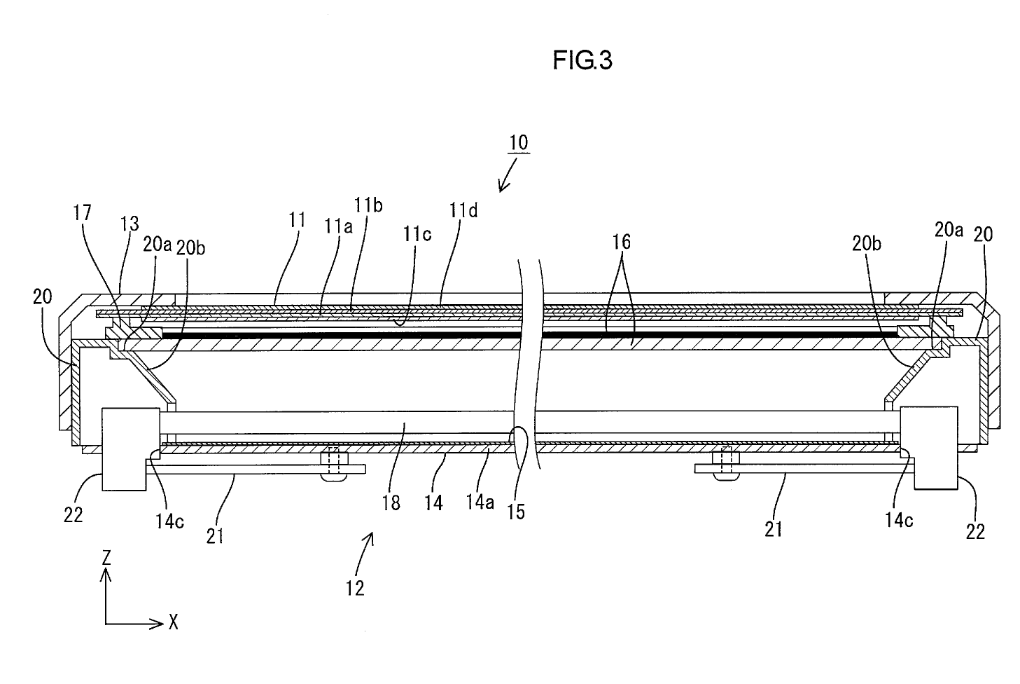

A first embodiment of the present invention will be described with reference to FIGS. 1 to 9. In some parts of the drawings, an X-axis, a Y-axis, and a Z-axis are shown as the respective axial directions corresponding to the directions shown in the respective drawings. The Y-axis direction is aligned with the vertical direction, and the X-axis direction is aligned with the horizontal direction. The upper side and the lower side shown in FIGS. 2 and 3 correspond to the front side and the rear side, respectively.

At first, a configuration of a television receiver TV with a liquid crystal device 10 will be described.

As illustrated in FIG. 1, the television receiver TV according to the present embodiment includes the liquid crystal display device 10, front and rear cabinets Ca and Cb between which the liquid crystal display device 10 is housed, a power source P, a tuner T, and a stand S. The liquid crystal display device (display device) 10 has a generally horizontally long square shape, and is housed in a vertical position. The liquid crystal display device 10, as shown in FIG. 2, includes a liquid crystal panel 11 as a display panel and a backlight unit (lighting device) 12 as an external light source, which are integrally held by a frame-shaped bezel 13 or the like.

The liquid crystal panel 11 and the backlight unit 12 of the liquid crystal display device 10 will be described (see FIGS. 2 to 4).

The liquid crystal panel (display panel) 11, as shown in FIG. 3, has a pair of glass substrates 11a and 11b affixed to each other via a predetermined gap, with liquid crystal enclosed between the glass substrates 11a and 11b. The glass substrate 11a has switching components (for example, TFTs) connected to a source wiring and a gate wiring orthogonal to each other, pixel electrodes connected to the switching components, an alignment film, or the like. The other glass substrate 11b has a color filter including color sections of, for example, R (red), G (green), and B (blue) in predetermined arrangement, counter electrodes, an alignment film, or the like. On the outer sides of the glass substrates 11a and 11b, polarizing plates 11c and lid are disposed.

As shown in FIGS. 2 and 3, the backlight unit 12 is a so-called direct backlight in which the light source is disposed immediately under the rear side of the liquid crystal panel 11. The backlight unit 12 is provided with a chassis 14 of a substantially box-like shape with an opening on the front side (light output side; facing the liquid crystal panel 11); a reflection sheet 15 laid within the chassis 14; a plurality of optical members 16 covering the opening of the chassis 14; and a frame 17 configured to hold the optical members 16. The chassis 14 houses a plurality of cold cathode tubes 18 (light sources); lamp clips 19 holding the cold cathode tubes 18 at a central portion thereof; and optically reflective lamp holders 20 blocking light to the end portions of the cold cathode tubes 18. The backlight unit 12 is further provided with inverter boards (power sources) 21 disposed on the rear side of the chassis 14, i.e., on the opposite side to the cold cathode tubes 18; and connectors 22 electrically relay-connecting the inverter boards 21 and the cold cathode tubes 18.

The chassis 14 is made of metal, such as an aluminum material. As shown in FIGS. 2 and 3, the chassis 14 includes a bottom plate 14a of a horizontally long square shape similar to the liquid crystal panel 11, and a pair of side plates 14b rising from the long side outer ends of the bottom plate 14a. The chassis 14 (bottom plate 14a) has a long side direction aligned with the X-axis direction (horizontal direction) and a short side direction aligned with the Y-axis direction (vertical direction). To the side plates 14b, the frame 17 and the bezel 13 can be secured by screws.

The reflection sheet 15 is made of a white synthetic resin with excellent optical reflectivity, and laid to cover substantially the entire area of the inner surface of the bottom plate 14a of the chassis 14. The reflection sheet 15 has the function of reflecting the light from the cold cathode tubes 18 toward the optical members 16 (light output side).

The optical members 16 have a rectangular shape in plan view similar to the bottom plate 14a of the chassis 14 or the liquid crystal panel 11. The optical members 16 are made of a light transmissive synthetic resin and interposed between the cold cathode tubes 18 on the rear side and the liquid crystal panel 11 on the front side. The optical members 16 include a diffuser plate, a diffuser sheet, a lens sheet, and a reflection type polarizing sheet, for example, successively from the rear side. The optical members 16 have the function of converting the light emitted by the cold cathode tubes 18, which are linear light sources, into even planar light, for example. The liquid crystal panel 11 is installed on a front surface side (upper surface side) of the optical members 16.

As shown in FIG. 2, the frame 17 has a rectangular shape conforming to the outer peripheral edge portions of the liquid crystal panel 11 and the optical members 16, for example. The frame 17 is made of a synthetic resin and has a black surface, for example, thus providing light blocking property. The frame 17 is disposed on the front side of the optical members 16 and configured to sandwich the outer peripheral edge portions of the optical members 16 with the side plates of the chassis 14 and the lamp holders 20 as will be described later. The frame 17 is also configured to receive the rear side of the liquid crystal panel 11 such that the liquid crystal panel 11 can be sandwiched between the frame 17 and the bezel 13 disposed on the front side of the liquid crystal panel 11.

The lamp clips 19 are made of a white synthetic resin with high optical reflectivity and, as shown in FIG. 2, disposed in a dispersed manner with a predetermined distribution on the inner surface of the bottom plate 14a of the chassis 14. The lamp clips 19 are fixedly attached to the bottom plate 14a of the chassis 14 and configured to hold a central portion of the cold cathode tubes 18 other than the end portions thereof such that a certain interval can be maintained between the cold cathode tubes 18 and the bottom plate 14a of the chassis 14.

The lamp holders 20 are made of a white synthetic resin with excellent optical reflectivity. As shown in FIGS. 2 and 3, the lamp holders 20 have a substantially box-shape extending along the short side direction of the chassis 14, with an opening on the rear side. Specifically, a pair of the lamp holders 20 is attached at the end portions of the chassis 14 in the long side direction such that the end portions of the cold cathode tubes 18 arranged side by side at the ends of the chassis 14 can be covered by the lamp holders 20 altogether. As shown in FIG. 3, the lamp holders 20 include a stepped optical member mount portion 20a on a front side surface such that the optical members 16 can be placed thereon. The lamp holders 20 also include an inclined portion 20b inclining from the optical member mount portion 20a toward the bottom plate 14a of the chassis 14.

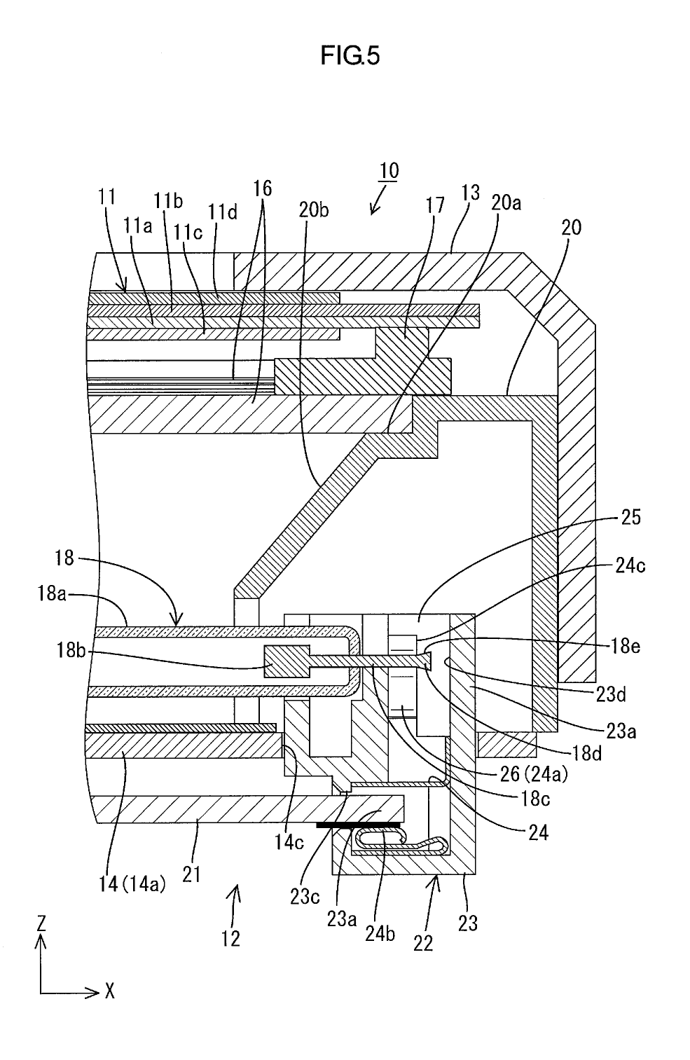

The inverter boards 21 include a board of synthetic resin (such as phenolic paper or glass-epoxy resin) on which a predetermined circuit pattern is formed and various electronic components (neither the circuit pattern nor the electronic components shown), such as a transformer, are mounted. The inverter boards 21 are connected to a main power source P of the liquid crystal display device 10. The inverter boards 21 have the function of supplying drive power to the cold cathode tubes 18 and controlling the turning on and off of the cold cathode tubes 18 by, for example, stepping up an input voltage from the main power source P to an output voltage higher than the input voltage and supplying the output voltage to the cold cathode tubes 18. Specifically, as shown in FIG. 3, a pair of the inverter boards 21 is attached to the rear side surface (opposite to the surface on which the cold cathode tubes 18 are installed) of the bottom plate 14a of the chassis 14 at the ends thereof in the long side direction, by screws. As shown in FIG. 5, the inverter boards 21 include a connector connecting portion 21a formed at an end portion thereof to which the connectors 22 are individually fittingly connected.

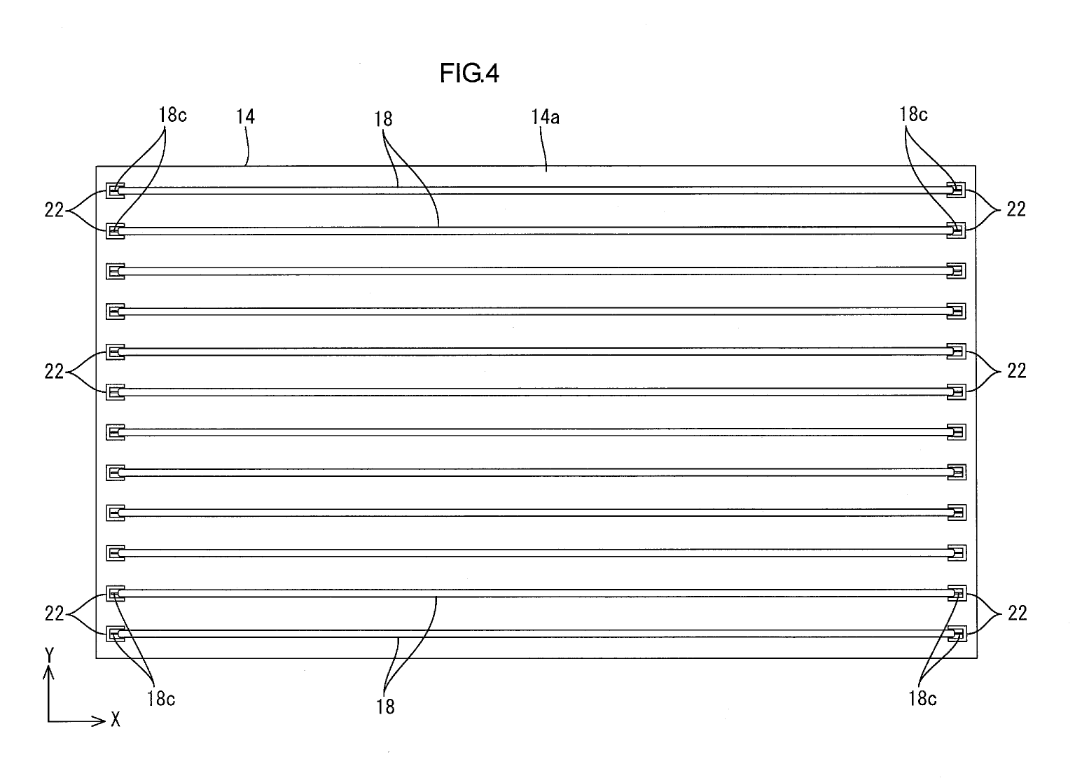

As shown in FIGS. 3 and 4, the connectors 22 are disposed on the chassis 14 in pairs at positions corresponding to the end portions of the cold cathode tubes 18, i.e., side by side at the ends of the bottom plate 14a in the long side direction with corresponding number to the cold cathode tubes 18 along the short side direction of the bottom plate 14a (the Y-axis direction; the direction in which the cold cathode tubes 18 are arranged side by side). The connectors 22 are arranged at substantially the same pitch as the cold cathode tubes 18 are arranged. The connectors 22 are positioned substantially aligned with the corresponding cold cathode tubes 18 with respect to the Y-axis direction. The bottom plate 14a of the chassis 14 includes a plurality of attaching holes 14c for attaching the connectors 22 at positions enabling the attaching of the corresponding connectors 22 along the Y-axis direction:

The cold cathode tubes 18 are a type of linear light source (tubular light source). As shown in FIG. 4, a plurality of the cold cathode tubes 18 is housed in the chassis 14 with the axes thereof aligned with the long side direction (the X-axis direction) of the chassis 14. The cold cathode tubes 18 are arranged parallel to each other in the short side direction (the Y-axis direction) of the chassis 14 at predetermined intervals with their axes substantially parallel to each other. Thus, the end portions of the cold cathode tubes 18 are arranged side by side along the short side direction at the end portions of the chassis 14 in the long side direction. The cold cathode tubes 18 adjacent to each other are arranged at substantially uniform intervals or pitch.

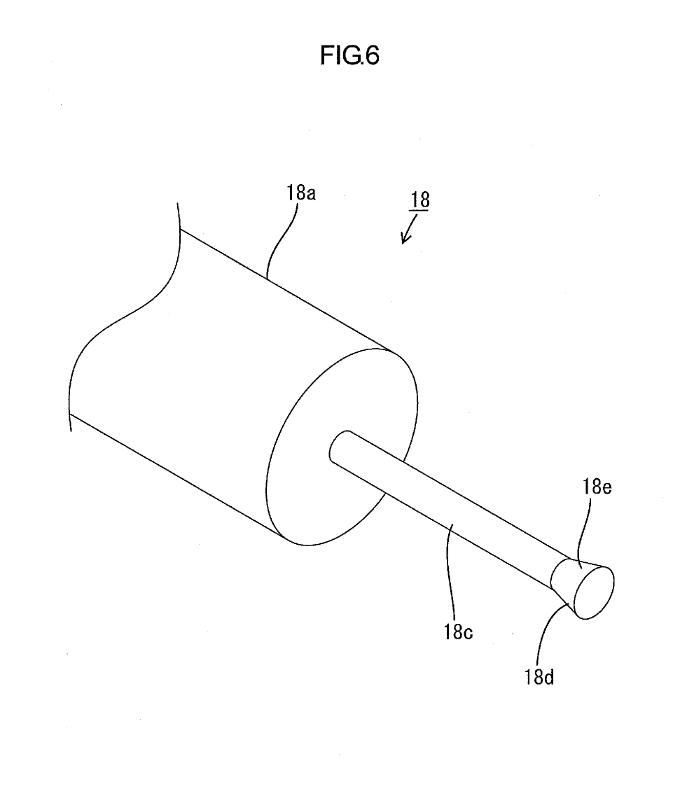

The cold cathode tubes 18 are a type of discharge tube and, as shown in FIGS. 5 and 6, include a thin glass tube (light emitting portion) 18a with sealed end portions and circular cross section; a pair of electrode portions 18b enclosed inside at the end portions of the glass tube 18a; and a pair of outer leads (conductive portions) 18c outwardly extending from the end portions of the glass tube 18a. The cold cathode tubes 18 are of the so-called straight tube type in which the glass tube 18a is linear in shape with the electrode portions 18b disposed in a dispersed manner in two directions (to the right and left in FIGS. 3 and 4). The glass tube 18a contains a light emitting substance such as mercury enclosed therein, with inner wall surfaces coated with phosphor (neither mercury nor phosphor shown), thus forming a light emitting portion as a whole. The electrode portions 18b and the outer leads 18c are made of an electrically conductive metal material. Preferably, the electrode portions 18b are made of an alloy with excellent sputtering resistance. The electrode portions 18b have a substantially cup-like shape and are housed in the end portions of the glass tube 18a. The outer leads 18c have a thin, substantially columnar shape, penetrating the sealed end of the glass tube 18a and outwardly protruding along the axis direction (the X-axis direction; length direction) of the glass tube 18a. An inner end portion of the outer leads 18c is connected to the electrode portions 18b within the glass tube 18a, such that the outer leads 18c and the electrode portions 18b have the same electric potential.

As shown in FIG. 6, the outer lead 18c extends from the end portions of the glass tube 18a along the axis direction of the cold cathode tube 18. The outer lead 18c has a thin wire shape as a whole with circular cross section. The outer lead 18c includes a retaining section 18d at the distal portion (end portion on the side opposite to the end portion closer to the glass tube 18a) with a greater width (diameter) than the width of the adjoining portion. The width (diameter) of the retaining section 18d at the end portion closer to the glass tube 18a is the same as a width of the adjoining portion (i.e., the original width of the outer lead 18c), while at the distal portion is greater than the end portion closer to the glass tube 18a. More specifically, the width (diameter) of the retaining section 18d is continuously increased from the side closer to the glass tube 18a toward the distal side such that the retaining section 18d has a substantially trapezoidal cross section with the upper side closer to the glass tube 18a and the lower side closer to the distal side (see FIG. 5). The retaining section 18d is formed by increasing a part of the outer lead 18c in width (diameter), for example. In other words, the retaining section 18d is integrally formed with the remaining part of the outer lead 18c.

A structure for connecting the cold cathode tubes 18 and the connectors 22 will be described.

As shown in FIGS. 5 and 7 through 9, the connectors 22 are provided with a connector housing 23 made of an insulating synthetic resin with a substantially block shape as a whole; and a connecting terminal 24 housed in the connector housing 23. The connectors 22 are assembled through the bottom plate 14a of the chassis 14. The connector housing 23 includes a light source receiving portion 23a inside the chassis 14, and a board receiving portion 23b outside the chassis 14. The light source receiving portion 23a receives the end portions (including the outer leads 18c) of the cold cathode tubes 18 inside the chassis 14, and the board receiving portion 23b receives the connector connecting portion 21a of the inverter boards 21 outside the chassis 14. The light source receiving portion 23a includes an arc-like shaped groove portion conforming to the outer shape of the end portion of the cold cathode tubes 18 to receive the end portion. The board receiving portion 23b includes a board insertion opening 23c facing the inverter boards 21. The inverter boards 21 can be inserted into or removed from the board insertion opening 23c along the X-axis direction (see FIG. 5). Further, the connector housing 23 includes a terminal housing chamber 23d configured to house the connecting terminal 24. The terminal housing chamber 23d is formed across the light source receiving portion 23a and the board receiving portion 23b, and includes an insertion channel 25 configured such that the outer lead 18c of the cold cathode tubes 18 is inserted. The terminal housing chamber 23d communicates with the board insertion opening 23c of the board receiving portion 23b. The insertion channel 25 is opened toward the front side (in the Z-axis direction) of the light source receiving portion 23a such that the outer lead 18c can be put in and out of the connectors 22 via the insertion channel 25 along the Z-axis direction.

As shown in FIG. 5, the connecting terminal 24 is housed in the terminal housing chamber 23d and has a size to lie across the light source receiving portion 23a and the board receiving portion 23b. The connecting terminal 24 includes a light source contacting portion 24a in contact with the outer lead 18c of the cold cathode tubes 18 and a board contacting portion 24b in contact with the connector connecting portion 21a of the inverter boards 21 at the end portions thereof, disposed respectively in the light source receiving portion 23a and the board receiving portion 23b.

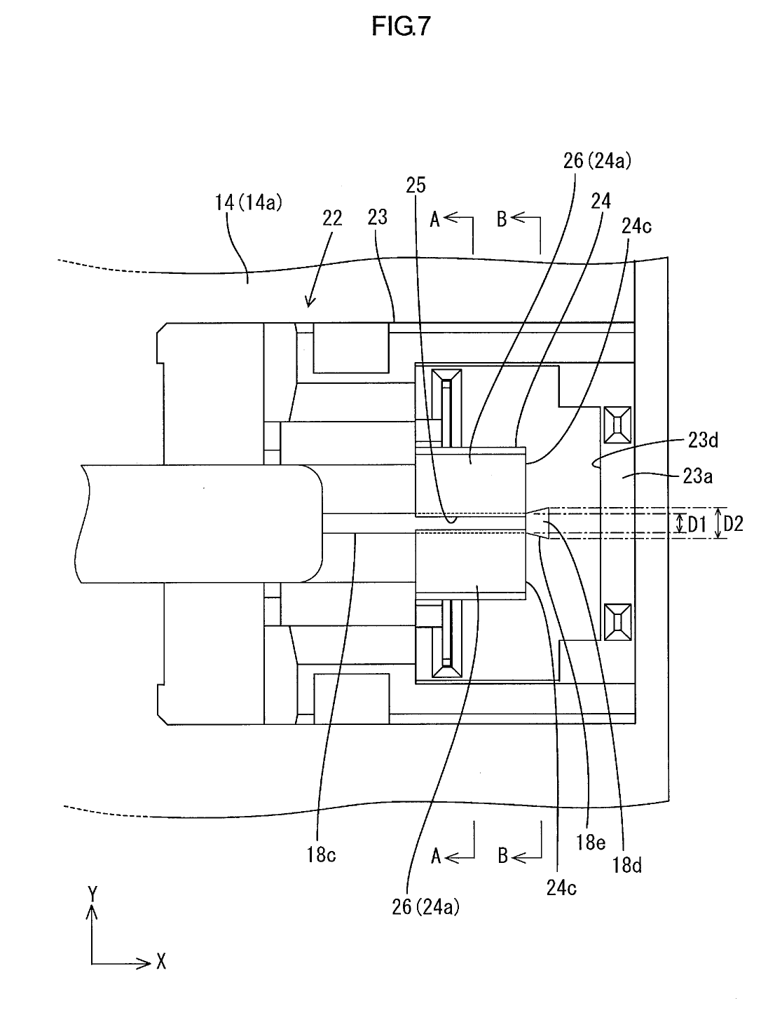

As shown in FIGS. 7 to 9, the light source contacting portion 24a includes a pair of elastic contact parts 26 configured to elastically contact the outer lead 18c while sandwiching the outer lead 18c. The pair of elastic contact parts 26 is disposed facing each other in the Y-axis direction such that the outer lead 18c can be elastically held therebetween. The outer lead 18c can be inserted into or removed from the pair of elastic contact parts 26 along the Z-axis direction through the insertion channel 25 of the terminal housing chamber 23d. The pair of elastic contact parts 26 are configured to be elastically deformed to open or close as the outer lead 18c is inserted or removed. When opened, the pair of elastic contact parts 26 move outwardly in the Y-axis direction, i.e., away from the outer lead 18c. Thus, by holding the outer lead 18c by the light source contacting portion 24a of the connecting terminal 24, the cold cathode tubes 18 and the inverter boards 21 can be connected via the connectors 22, and thereby the drive power output from the inverter boards 21 can be input to the outer lead 18c and the electrode portions 18b of the cold cathode tubes 18.

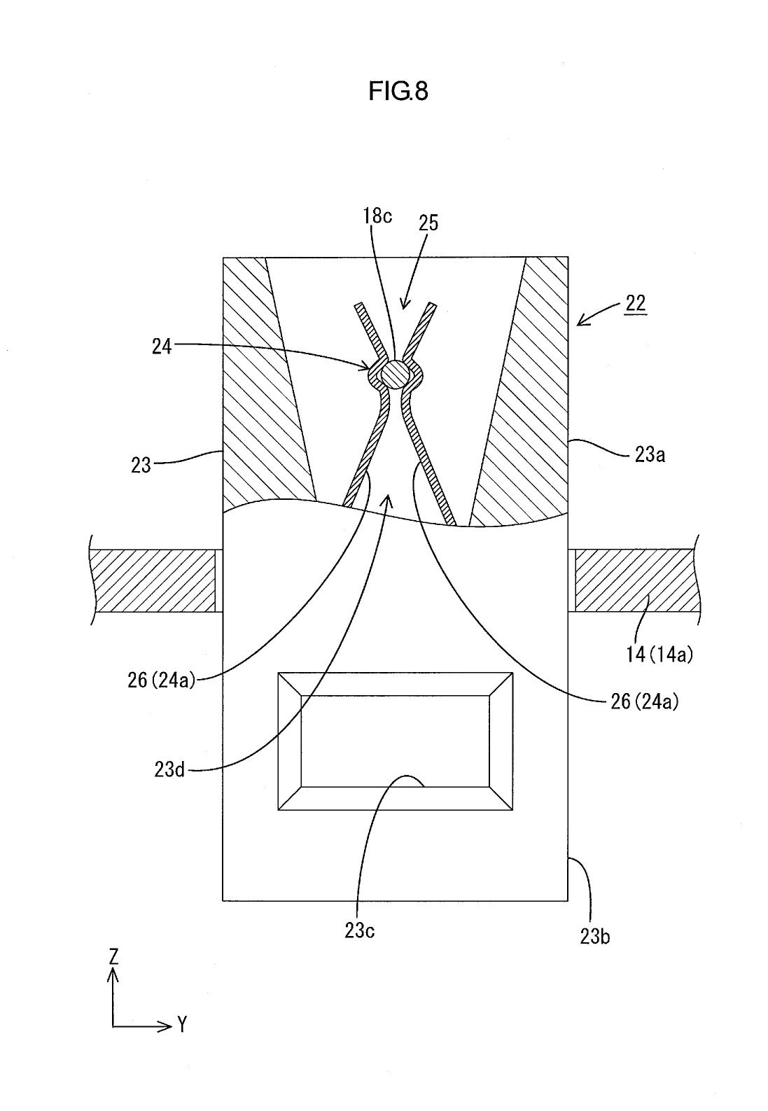

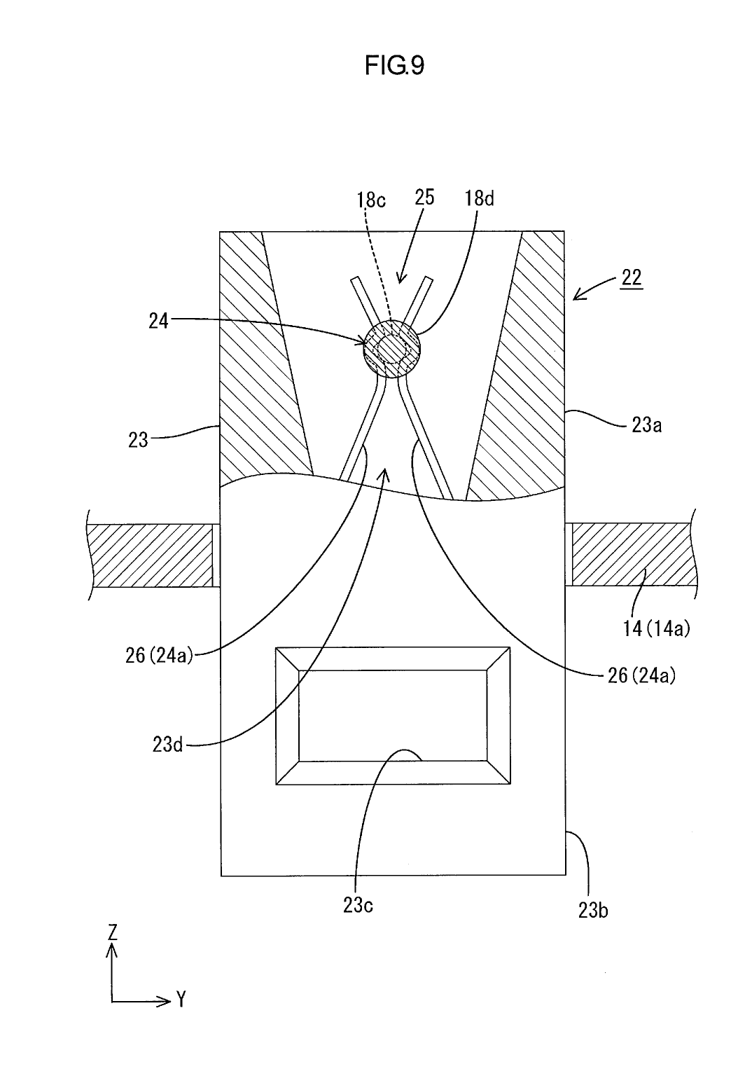

The connection of the outer lead 18c and the connecting terminal 24 will be described in detail with reference to FIGS. 7 and 8. The outer lead 18c is sandwiched by the elastic contact parts 26 of the connecting terminal 24 at the portion with the uniform width (diameter) other than the distal portion (retaining section 18d). On the other hand, the retaining section 18d of the outer lead 18c is positioned closer to the distal side than the section held section, and outside the elastic contact parts 26 (on the opposite side to the glass tube 18a), as shown in FIGS. 7 and 9. As described above, the width of the retaining section 18d is continuously increased from the side closer to the glass tube 18a toward the distal side such that the distal end of the retaining section 18d has a maximum width D2 (particularly the width in the Y-axis direction, or the sandwiching direction of the elastic contact parts 26) (see FIG. 7). The width D2 of the retaining section 18d is greater than a width D1 with which the outer lead 18c is sandwiched by the elastic contact parts 26. The retaining section 18d includes a side surface 18e faced toward the elastic contact parts 26 (connecting terminal 24). The side surface 18e angled to a surface 24c of the connecting terminal 24 facing the retaining section 18d, thus forming a step. As a result, when force is applied to move the outer lead 18c in the direction pulled off the connecting terminal 24 (in the X-axis direction), the retaining section 18d (i.e., side surface 18e) interferes with the connecting terminal 24 (i.e., the surface 24c facing the retaining section 18d), thereby limiting the movement of the outer lead 18c.

An operation of the present embodiment with the above-described structure will be described.

When attaching or detaching the cold cathode tubes 18 to or from the connecting terminal 24, the outer lead 18c is positioned over the insertion channel 25 with the axes of the cold cathode tubes 18 aligned with the X-axis, and inserted into or removed from between the pair of elastic contact parts 26 along the Z-axis direction. Then, the elastic contact parts 26 are elastically deformed to open or close as the outer lead 18c is inserted or removed, thus permitting the insertion or removal of the outer lead 18c. When the outer lead 18c is sandwiched by the elastic contact parts 26, the electrically connected state between the cold cathode tubes 18 and the inverter boards 21 via the connectors 22 is maintained.

When the liquid crystal display device 10 is transported, for example, the liquid crystal display device 10 may be subjected to strong vibrations or shock. As a result, the connection between the connecting terminal 24 and the outer lead 18c may be adversely affected. Particularly, when the outer lead has a simple wire shaped configuration with a uniform width, the outer lead may be pulled off the connecting terminal 24 due to movement of the cold cathode tubes 18 along the axis direction (the X-axis direction), possibly resulting in disconnection between the connecting terminal 24 and the outer lead. However, according to the present embodiment, the outer lead 18c includes the retaining section 18d at the distal portion with a greater width than the width of the adjoining portion. Thus, when force is applied in a direction to pull the outer lead 18c off, the retaining section 18d interferes with the connecting terminal 24 (more specifically, the side surface 18e of the retaining section 18d and the surface 24c of the connecting terminal 24 facing thereto are abutted on each other while conforming to the side surface 18e). As a result, the movement of the outer lead 18c in the pulling-off direction can be limited, and thereby the outer lead 18c can be prevented from coming off the connecting terminal 24.

As described above, the backlight unit 12 according to the present embodiment is provided with the cold cathode tubes 18 including the glass tube 18a and the outer leads 18c extending from the end portions of the glass tube 18a; the inverter boards 21 that supply drive power to the cold cathode tubes 18; and the connectors 22 including the connecting terminal 24 configured to sandwich the outer leads 18c such that the cold cathode tubes 18 can be connected to the inverter boards 21. The outer leads 18c include the retaining section 18d with a width greater than a width of the adjoining portion such that the outer leads 18c can be prevented from coming off the connecting terminal 24 by the retaining section 18d interfering with the connecting terminal 24.

In this configuration, even when the backlight unit 12 is subjected to strong vibrations or shock during assembly or transport, the outer leads 18c can be prevented from inadvertently coming off the connecting terminal 24 by the retaining section 18d of the cold cathode tubes 18, which interferes with the connecting terminal 24 of the connectors 22. Thus, vibration resisting performance and shock resisting performance can be ensured, and thereby the connection reliability between the cold cathode tubes 18 and the connectors 22 can be improved. Further, in the present configuration, the connection reliability is improved by simply varying the width of the outer leads 18c of the cold cathode tubes 18 without a complicated structure of the connectors 22 to which the cold cathode tubes 18 are connected. Accordingly, cost reduction can be achieved.

According to the present embodiment, the width D2 of the retaining section 18d is greater than the width D1 with which the outer leads 18c are sandwiched by the connecting terminal 24. Thus, when force is applied to pull the outer leads 18c off the connecting terminal 24, the retaining section 18d is abutted on the connecting terminal 24 such that the outer leads 18c can be prevented from coming off the connecting terminal 24, thereby improving the connection reliability between the outer leads 18c and the connecting terminal 24.

Further, according to the present embodiment, the retaining section 18d is formed closer to the distal side of the outer leads 18c than the portion sandwiched by the connecting terminal 24. Thus, when force is applied to pull the outer leads 18c off the connecting terminal 24, the movement of the outer leads 18c is limited by the retaining section 18d formed at the distal end of the outer leads 18c that abuts on the connecting terminal 24 with the surface 24c facing the retaining section 18d. In this way, the outer leads 18c can be prevented from coming off.

Further, according to the present embodiment, the width of the retaining section 18d is greater at the distal side than at the side closer to the glass tube 18a such that the side surface 18e of the retaining section 18d facing the connecting terminal 24 intersects the opposite surface 24c of the connecting terminal 24. Thus, when the outer leads 18c are moved in the pulling-off direction, the retaining section 18d and the connecting terminal 24 become abutted on each other while conforming to the side surface 18e of the retaining section 18d. In this way, the shock upon contact can be reduced, and thereby damage to the outer leads 18c can be avoided.

Further, according to the present embodiment, the retaining section 18d is integrally formed with the outer leads 18c. Thus, the number of components can be decreased, contributing to cost reduction.

Further, according to the present embodiment, the connecting terminal 24 includes the pair of elastic contact parts 26 configured to elastically contact the outer lead 18c. Thus, when the outer leads 18c are sandwiched by the pair of elastic contact parts 26 of the connecting terminal 24, the pair of elastic contact parts 26 elastically contacts the outer leads 18c. Therefore, good mutual connection can be maintained and better connection reliability can be obtained.

### Second Embodiment

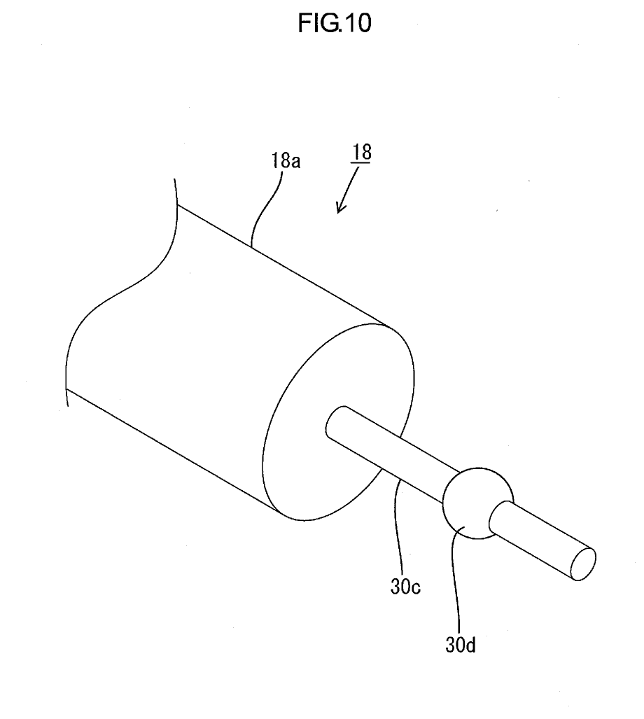

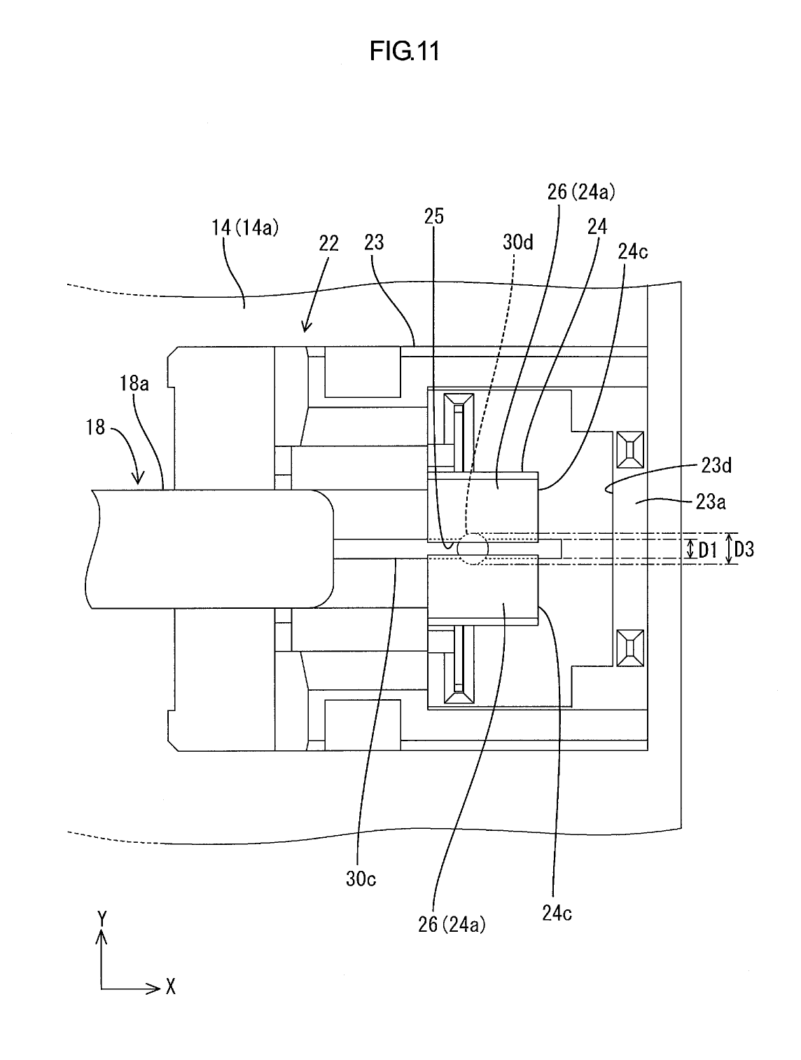

A second embodiment of the present invention will be described with reference to FIGS. 10 and 11. In the second embodiment, the retaining section has a modified configuration. Components similar to the first embodiment will be designated with similar reference signs and redundant description will be omitted.

FIG. 10 is a perspective view illustrating a configuration of the end portion of the cold cathode tube according to the present embodiment. FIG. 11 is a plan view illustrating a configuration for connecting the cold cathode tube and the connector.

As shown in FIG. 10, an outer lead (conductive portion) 30c extending from the end portion of the cold cathode tube 18 includes a spherical retaining section 30d substantially at a central position between the ends of the outer lead 30c in its extending direction. The retaining section 30d has a width (diameter) greater than a width of the outer lead 30c at adjoining portions. The retaining section 30d is integrally formed with the outer lead 30c. The outer lead 30c has a substantially uniform width at the portions other than the retaining section 30d.

When the cold cathode tube 18 is connected to the connecting terminal 24 of the connectors 22, as shown in FIG. 11, the retaining section 30d of the outer lead 30c, together with its adjoining portions, is sandwiched by the pair of elastic contact parts 26 (connecting terminal 24). The retaining section 30d has a maximum width D3 (particularly the width in the Y-axis direction, or the width in the sandwiching direction of the elastic contact parts 26) greater than the width D1 with which the outer lead 30c is sandwiched by the connecting terminal 24. Further, because the retaining section 30d is spherical, the surfaces of the retaining section 30d facing (i.e., sandwiched by) the connecting terminal 24 (elastic contact parts 26) are arc-like shaped.

As described above, according to the present embodiment, the retaining section 30d is formed at the portion of the outer lead 30c that is sandwiched by the connecting terminal 24. Thus, when force is applied to pull the outer lead 30c off the connecting terminal 24 in the Y-axis direction, strong friction is caused between the retaining section 30d and the connecting terminal 24. Thus, the outer lead 30c can be prevented from coming off.

Further, according to the present embodiment, the surfaces of the retaining section 30d facing the connecting terminal 24 are arc-like shaped. In this way, the retaining section 30d and the connecting terminal 24 come into contact with each other while conforming to the arc-like shaped surfaces. Thus, the outer lead 30c can be prevented from being subjected to localized shock when the outer lead 30c is moved, and thereby damage to the lead 30c can be avoided.

### Third Embodiment

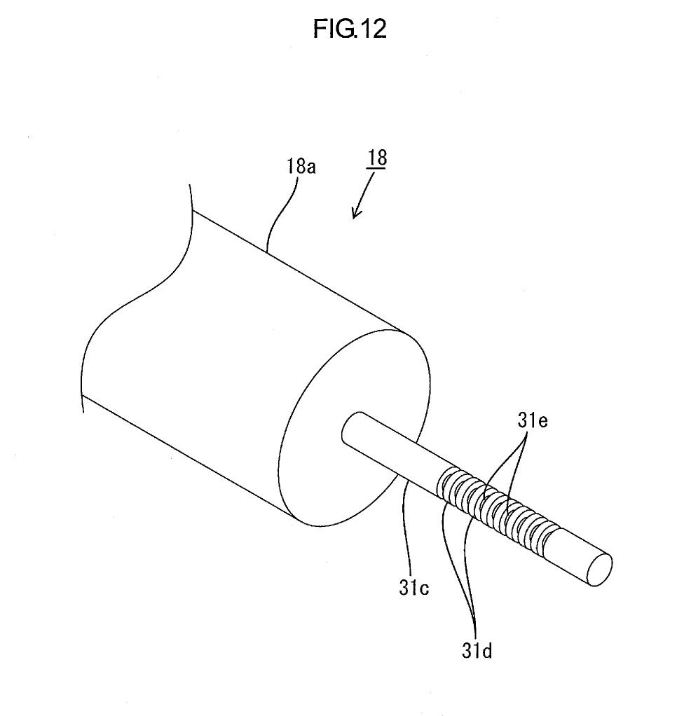

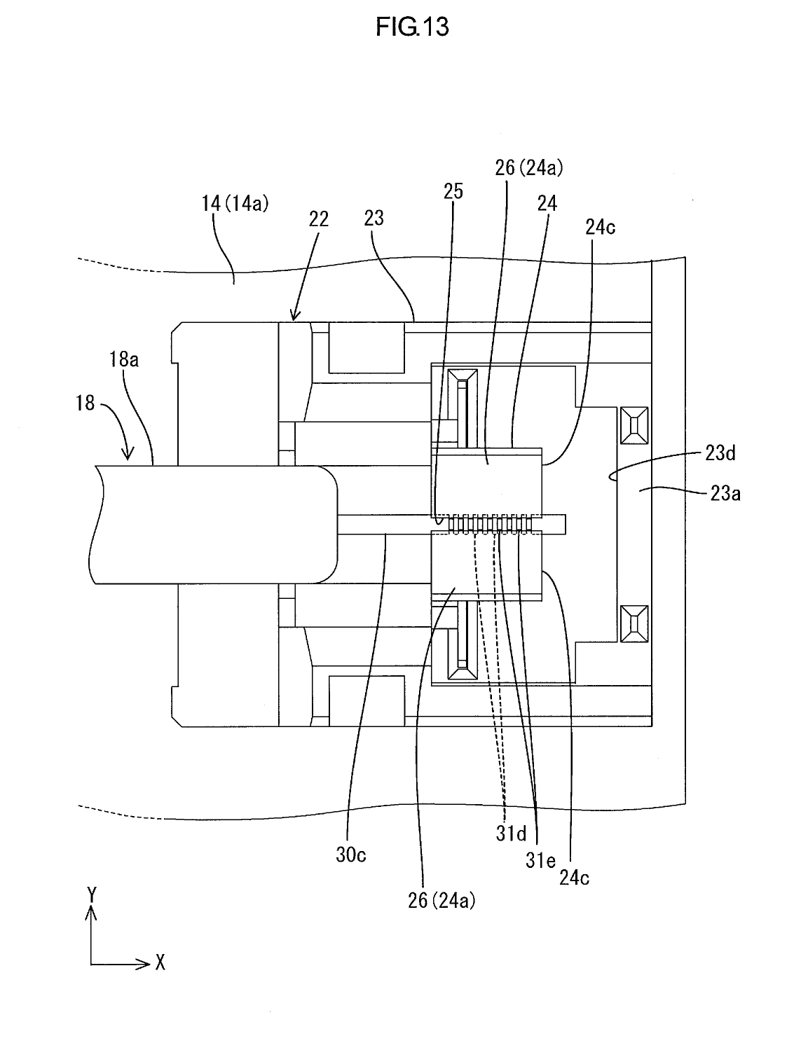

A third embodiment of the present invention will be described with reference to FIGS. 12 and 13. In the third embodiment, the retaining section has another modified configuration. Components similar to those of the first embodiment will be designated with similar signs and redundant description will be omitted.

FIG. 12 is a perspective view illustrating a configuration of the end portion of the cold cathode tube according to the present embodiment. FIG. 13 is a plan view illustrating a configuration for connecting the cold cathode tube and the connector.

As shown in FIG. 12, an outer lead (conductive portion) 31c extending from the end portion of the cold cathode tube 18 includes a plurality of groove portions (concave portions) 31e at predetermined intervals substantially at a central position between the ends of the outer lead 31c along its extending direction. Each of the groove portions 31e extends along a direction intersecting the extending direction of the outer lead 31c (particularly a direction orthogonal to the extending direction according to the present embodiment) and have a width (diameter) smaller than a width of the adjacent portions. Between the adjacent groove portions 31e, retaining sections (convex portions) 31d with a width (diameter) greater than a width of the adjoining portions (groove portions 31e) are formed, respectively in a ridge shape adjacent to the groove portions 31e. The retaining sections 31d extend along a direction intersecting the extending direction of the outer lead 31c (a direction orthogonal to the extending direction according to the present embodiment) similarly to the groove portions 31e, thus forming stepped surfaces. Particularly, according to the present embodiment, the retaining sections 31d have the same width (diameter) as the original width (diameter) of the outer lead 31c. Each of the retaining sections 31d and the groove portions 31e is continuously formed throughout the circumference of the outer lead 31c.

As shown in FIG. 13, when the cold cathode tube 18 is connected to the connecting terminal 24 of the connectors 22, the retaining sections 31d and the groove portions 31e of the outer lead 31c are sandwiched by the pair of elastic contact parts 26 (connecting terminal 24). At this time, because the width of the outer lead 31c in the radial direction is greater at the retaining sections 31d than at the groove portions 31e, the side surfaces of the retaining sections 31d contact the elastic contact parts 26 while gaps are provided between the groove portions 31e and the elastic contact parts 26. Thus, when force is applied to pull the cold cathode tube 18 off in the Y-axis direction, the retaining sections 31d can be deformed in the gap between the groove portions 31e and the elastic contact parts 26 (in the X-axis direction) while the retaining sections 31d remains in contact with the elastic contact parts 26.

As described above, according to the present embodiment, the outer lead 31c includes the retaining sections 31d and the groove portions 31e adjacent to each other. Thus, when force is applied to pull the outer lead 31c off the connecting terminal 24 is applied, the retaining sections 31d are deformed toward the groove portions 31e such that the contact resistance between the retaining sections 31d and the connecting terminal 24 is increased, and therefore the friction between the outer lead 31c (retaining sections 31d) and the connecting terminal 24 can be increased. Accordingly, the outer lead 31c can be prevented from coming off.

Further, according to the present embodiment, the retaining sections 31d form the ridges extending in a direction intersecting the extending direction of the outer lead 31c. Thus, when force is applied to the outer lead 31c in the extending direction (pulling-off direction), greater friction can be caused between the outer lead 31c (retaining sections 31d) and the connecting terminal 24 than a dot-like retaining section, for example. Accordingly, the outer lead 31c can be prevented from coming off more effectively.

### Fourth Embodiment

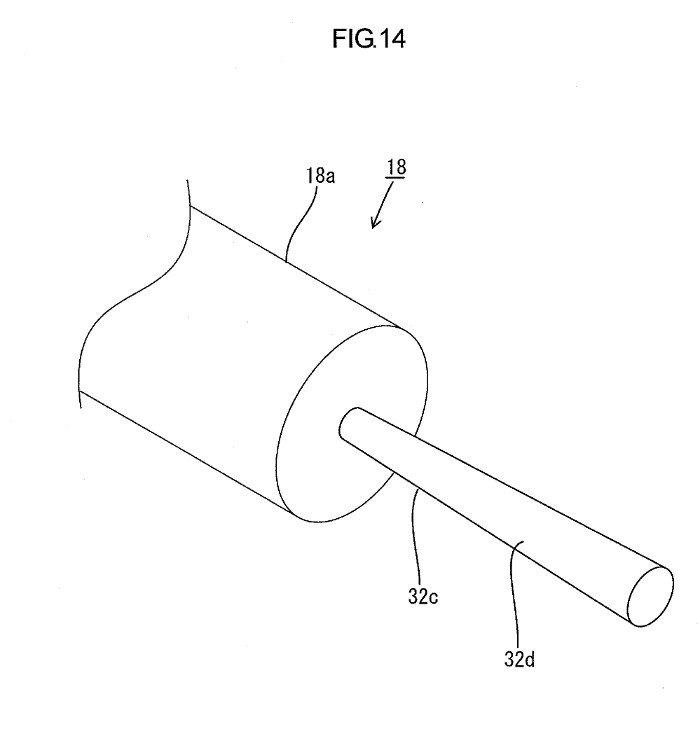

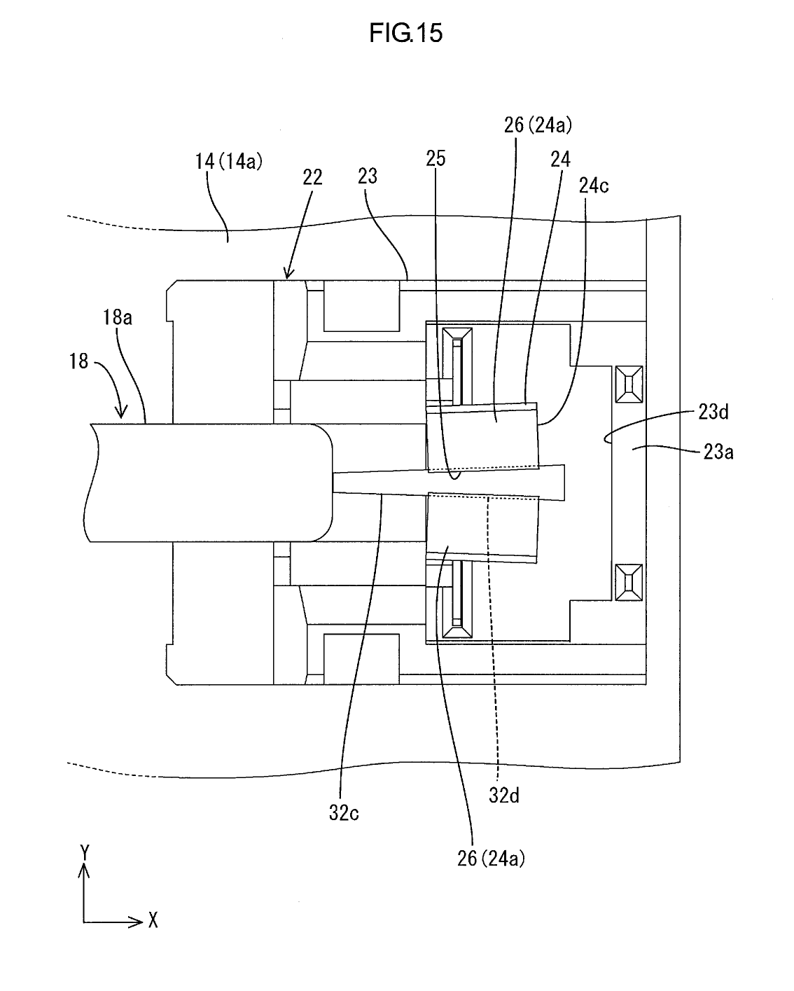

A fourth embodiment of the present invention will be described with reference to FIGS. 14 and 15. In the fourth embodiment, the retaining section has a further modified configuration. Components similar to those of the first embodiment will be designated with similar signs and redundant description will be omitted.

FIG. 14 is a perspective view illustrating a configuration of the end portion of the cold cathode tube according to the present embodiment. FIG. 15 is a plan view illustrating a configuration for connecting the cold cathode tube and the connector.

As shown in FIG. 14, an outer lead (conductive portion) 32c extending from the end portion of the cold cathode tube 18 has a continuously increasing width (diameter) from the side closer to the glass tube 18a toward the distal side such that the width is at a maximum at the distal portion of the outer lead 32c. The distal side portion of the outer lead 32c includes a retaining section 32d with a greater width (diameter) than a width on the side closer to the glass tube 18a.

As shown in FIG. 15, when the cold cathode tube 18 is connected to the connecting terminal 24 of the connectors 22, the retaining section 32d of the outer lead 32c is sandwiched by the pair of elastic contact parts 26 (connecting terminal 24). At this time, the pair of elastic contact parts 26 contacts the circumferential surface of the outer lead 32c while conforming to the varying width of the outer lead 32c (retaining section 32d). Thus, the outer lead 32c is sandwiched by the elastic contact parts 26 with a smaller width on the side closer to the glass tube 18a and with increasingly greater width toward the distal side of the outer lead 32c.

As described above, according to the present embodiment, the width of the outer lead 32c is increased from the side closer to the glass tube 18a toward the distal side, and the distal side portion of the outer lead 32c constitutes the retaining section 32d. Thus, the effect of preventing the outer lead 32c from coming off can be obtained by the simple configuration in which the width of the outer lead 32c is continuously varied such that the retaining section 32d is formed, thereby contributing to cost reduction. Because the width of the outer lead 32c is continuously varied, the connecting terminal 24 can readily conform to the side surface of the outer lead 32c. Thus, good connection between the outer lead 32c and the connecting terminal 24 can be obtained.

### Other Embodiments

While the present invention has been described with reference to embodiments, the present invention is not limited to the embodiments above described and illustrated with reference to the drawings, and the following embodiments may be included in the technical scope of the present invention.

(1) In the first embodiment, the retaining section has a trapezoidal cross section with the side surface facing the connecting terminal positioned to intersect the surface of the connecting terminal facing the retaining section by way of example. However, the shape of the retaining section is not limited to such configuration. For example, the retaining section may have a rectangular cross section with a surface facing a surface of the connecting terminal, substantially parallel to each other in a head-on manner.

(2) While in the second embodiment the retaining section has a substantially spherical cross section with the surfaces facing the connecting terminal in arc-like shape by way of example, the shape of the retaining section is not limited to such configuration. For example, the cross sectional shape of the retaining section may be elliptical, polygonal and the like.

(3) While in the third embodiment the retaining sections and the groove portions are respectively formed in a direction orthogonal to the extending direction of the outer lead, i.e., along the circumferential direction of the outer lead by way of example, the retaining sections and the groove portions can provide the retaining effect as long as they extend in a direction intersecting the extending direction of the outer lead. Further, while each of the retaining sections and the groove portions extends continuously throughout the circumference of the outer lead, the retaining sections and/or the groove portions may be configured as ridges, grooves, or dots formed partially along the circumference of the outer lead.

(4) While in the fourth embodiment the width of the outer lead is continuously increased from the side closer to the glass tube toward the distal side by way of example, the width of the outer lead in the sandwiching direction may be increased in a stepwise manner from the side closer to the glass tube toward the distal side.

(5) While in the foregoing embodiments the retaining section is integrally formed with the outer lead, the retaining section may be a separate member connected to the outer lead.

(6) While in the foregoing embodiments the width (diameter) of the retaining section is greater in every radial direction than the width of the adjoining portion by way of example, the present invention includes any configuration in which the width of the retaining section is greater than the adjoining portion at least in the direction in which the outer lead is sandwiched by the connecting terminal.

(7) While in the foregoing embodiments the connecting terminal includes the pair of elastic contact parts configured to sandwich the outer lead, a single elastic contact part with a receiving portion facing thereto may be adopted such that the outer lead can be sandwiched between the elastic contact part and the receiving portion.

(8) While in the foregoing embodiments the end portion of the inverter boards can be inserted into or removed from the connectors, a lead wire may be drawn out from the connectors to the rear side of the chassis and connected to the inverter boards directly or indirectly.

(9) While in the foregoing embodiments the cold cathode tubes of the straight tube type are used by way of example, the present invention includes a configuration in which a cold cathode tube with a curved shape, such as U-shape, is used.

(10) While in the foregoing embodiments the cold cathode tubes are used as light sources, the present invention includes a configuration in which other types of light source, such as hot cathode tubes, are used.

(11) While in the foregoing embodiments liquid crystal display devices using a liquid crystal panel as a display panel has been described by way of example, the present invention may be applied to display devices using other types of display panels.

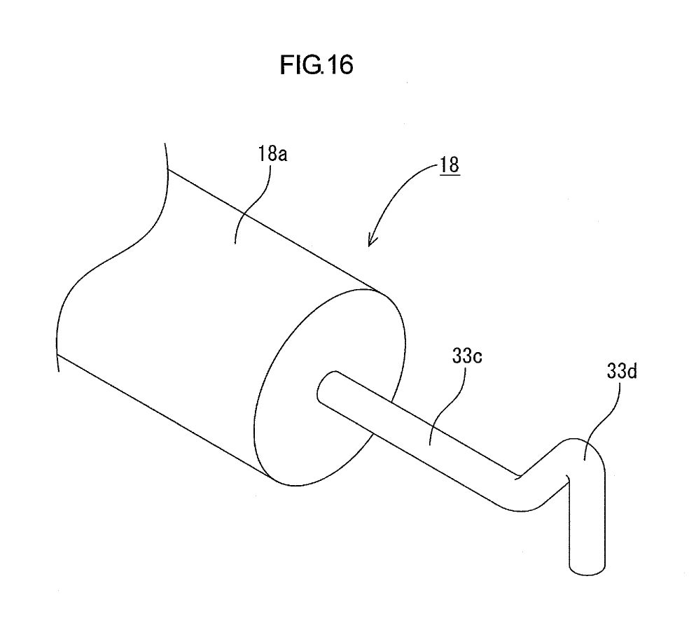

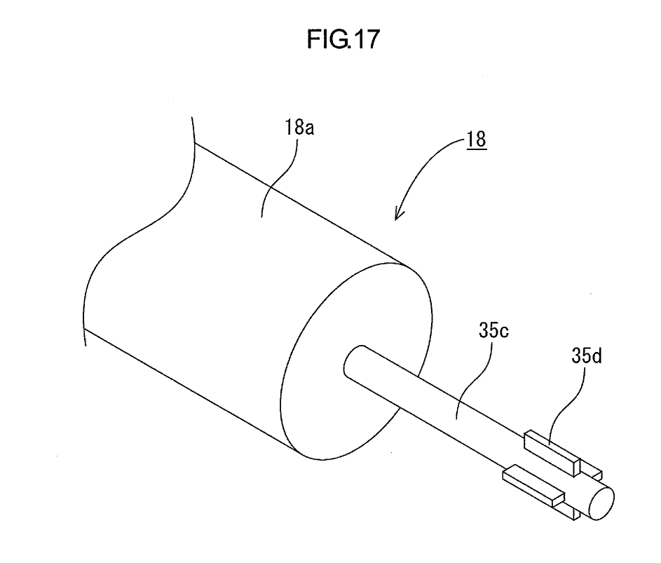

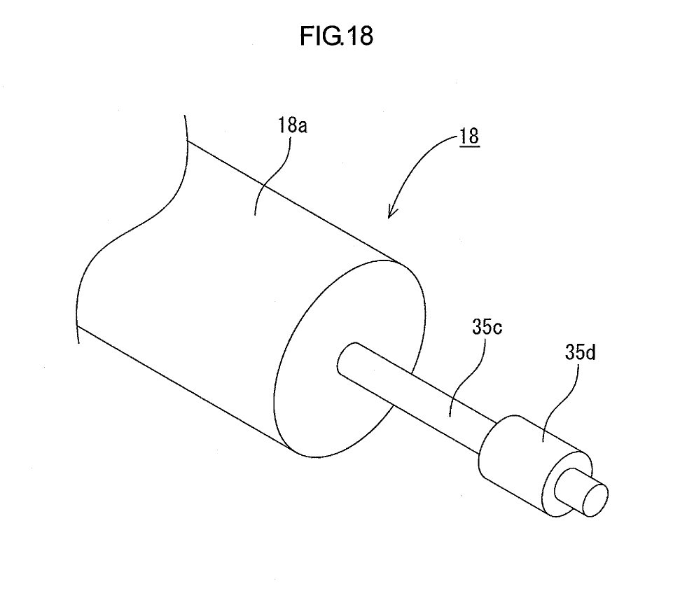

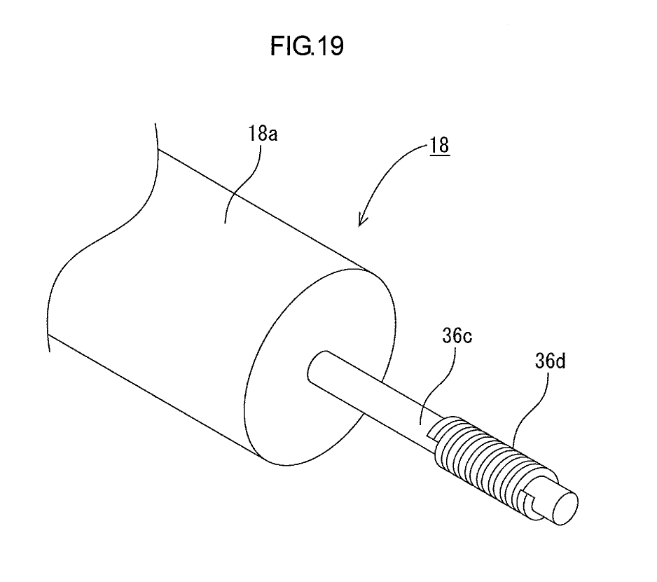

(12) The retaining section may be configured as illustrated in FIGS. 16 to 19. FIG. 16 illustrates a retaining section 33d of the cold cathode tube 18 which is formed by bending the tip of an outer lead 33c. FIG. 17 illustrates a retaining section 34d of the cold cathode tube 18 which is a projecting rolled portion formed by forging an outer lead 34c. FIG. 18 illustrates a retaining section 35d of the cold cathode tube which is a separate, doughnut-shaped retaining member pressure-inserted onto an outer lead 35c. FIG. 19 illustrates a retaining section 36d of the cold cathode tube 18 which is a separate, string-shaped retaining member wound on an outer lead 36c.

### EXPLANATION OF SYMBOLS

10: Liquid crystal display device (Display device)
11: Liquid crystal panel (Display panel)
12: Backlight unit (Lighting device)
18: Cold cathode tube (Light source)
18a: Glass tube (Light emitting portion)
18c: Outer lead (Conductive portion)
18d: Retaining section
18e: Side surface of retaining section facing connecting terminal
21: Inverter board (Power source)
22: Connector
24: Connecting terminal
24c: Surface of connecting terminal facing retaining section
26: Elastic contact part
30c: Outer lead (Conductive portion)
30d: Retaining section
31c: Outer lead (Conductive portion)
31d: Retaining section (Convex portion)
31e: Groove portion (Concave portion)
32c: Outer lead (Conductive portion)
32d: Retaining section
TV: Television receiver

1. A lighting device comprising:
a light source including a light emitting portion and a conductive portion extending from an end portion of the light emitting portion;
a power source configured to supply drive power to the light source; and
a connector including connecting terminals holding the conductive portion therebetween to connect the light source to the power source, wherein
the conductive portion includes a retaining section larger in width than another section of the conductive portion such that the retaining section is caught by the connecting terminals and remains held by the connecting terminals.

2. The lighting device according to claim 1, wherein the width of the retaining section is larger than a distance between the connecting terminals with which the conductive portion is held.

3. The lighting device according to claim 2, wherein the retaining section is located closer to a distal end of the conductive portion than a section of the conductive portion held by the connecting terminals.

4. The lighting device according to claim 3, wherein
the retaining section is larger in width on a distal side than on a side closer to the light emitting portion; and
the retaining section includes a side surface faced toward the connecting terminal and angled to a surface of the connecting terminal.

5. The lighting device according to claim 2, wherein the retaining section is provided in a section of the conductive portion held by the connecting terminals.

6. The lighting device according to claim 5, wherein the retaining section includes an arc-like shaped surface facing the connecting terminals.

7. The lighting device according to claim 5, wherein the retaining section includes a stepped surface facing the connecting terminal.

8. The lighting device according to claim 1, wherein:
the conductive portion includes a convex portion and a concave portion adjacent to each other; and
the convex portion is the retaining section.

9. The lighting device according to claim 8, wherein the retaining section forms a ridge extending in a direction intersecting an extending direction of the conductive portion.

10. The lighting device according to claim 8, wherein the retaining section includes stepped surfaces facing the connecting terminal.

11. The lighting device according to claim 1, wherein
the width of the conductive portion is gradually increased from a side closer to the light emitting portion toward a distal side, and
the retaining section is a distal side portion of the conductive portion.

12. The lighting device according to claim 1, wherein the retaining section is formed by bending the conductive portion.

13. The lighting device according to claim 1, wherein the retaining section is formed by forging the conductive portion.

14. The lighting device according to claim 1, wherein the retaining section is formed by pressure-inserting a retaining member onto the conductive portion.

15. The lighting device according to claim 1, wherein the retaining section is formed by winding a retaining member on the conductive portion.

16. The lighting device according to claim 1, wherein the retaining section is integrally formed with the conductive portion.

17. The lighting device according to claim 1, wherein the connecting terminals includes a pair of elastic contact parts elastically in contact with the conductive portion.

18. A display device comprising:
the lighting device according to claim 1; and
a display panel configured to provide a display by utilizing light from the lighting device.

19. The display device according to claim 18, wherein the display panel is a liquid crystal panel using liquid crystal.

20. A television receiver comprising the display device according to claim 18.
